(19) United States
(12) Patent Application Publication
(10) Pub. No.: US 2005/0024820 A1
(43) Pub. Date: Feb. 3, 2005

(54) Casing structure of a portable electronic device

(76) Inventors: Yu Chen, Taipei City (TW); Chen-Wang Chou, LuChou City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/628,340

(22) Filed: Jul. 29, 2003

(51) Int. Cl. G06F 1/16

(52) U.S. Cl. 361/686

(57) ABSTRACT

The present invention is related to a casing structure of a portable electronic device, the predetermined casing structure of the portable electronic device made by bendable metal. There is an installing room located in the casing for installing and positioning electronic elements. A positioning region located on the surface of the casing for installing external elements. An opening being on other surface excluding the surface with the positioning region so as to that the electronic elements entering to the installing room. An extendable covering body or folded plate is installed at the opening. A decoration member is attached to the surface of the casing of the present invention to enhance its mien, accompanying a more artistic visage and content the demand of customization.

### FIELD OF INVENTION

The present invention is related to a casing structure of a portable electronic device, especially a portable electronic device casing made by bendable metal and simplified assembly element, and able to have decorations or carvings on the surface of the casing, accompanying a more artistic appearance.

### BACKGROUND OF THE INVENTION/PRIOR ART

Computer, communication, consumer-electronic the so-called 3C products are quite popular in recent years, which the ability of portable entails, thus thirsting for lightweight material. Other than engineering plastics, low specific weight, light metal sheet, e.g., Aluminum sheet, Magnesium sheet, Titanium sheet etc. are also the preference hereafter. Nonetheless, engineering plastics are still mainly the structure material for the prevailing portable product. For the time being, its function can fulfill the demand of portable products, e.g., strength, light, low cost, easy to fabricate, coordinate peripheral firms lightly etc. However, engineering plastic still has the following shortcomings:

Other than lightweight, the notebook casing body currently on the market must also have the rigidity to guard inner elements. Under the tide pursuing a lightweight slim compact portable product, the demanding issue of various plastic materials' rigidity, capability of heat dissipation, and the vast heat generated during the operation of the central processing unit (CPU) brittle and deform adjacent texture are insufficiently met. Needing of new product material characteristics are gradually surfacing, e.g., shielding of electromagnetic interference (EMI), recyclable etc. which makes plastic materials inadequate. Portable product must also competent of enduring impacts incurred while bearing and shocks from a decline. Consequently, a firm casing is prerequisite. On the other hand, the color of engineering plastic of prior art is monotonous to an user who is particular about aspect, it truly lack the terms to allure user purchasing. Therefore, pondering over the market, consumers, to some extent, also take mien into consideration while consuming.

Referring to FIG. 1, which is an exploded view of a notebook in prior arts. As shown in FIG. 1, the assemble structure of prior art notebook comprises of four or more parts, including a liquid crystal display (LCD) frame 9′, upper lid 10′ and lower lid 12′ which interlocks with each other, and a positioning frame 11′ located between upper lid 10′ and lower lid 12′ which is used for enhancing rigidity and allocating position for electronic element. In addition, upper 10′ and lower lid 12′ is for guarding, separating positioning frame 11′ and the electronic element laid on it. On the other hand, LCD frame 9′, upper lid 10′ and lower lid 12′ are also an essential manner of appearance. Nowadays, the industry is heading into an epoch of flimsy gain. In order to retain competition in business, one must have to lower cost effectively. Seeking lighter notebook, better EMI preclusion, additional alteration of the exterior casing are the main objective of the present invention under the condition of curtailing elements.

### SUMMARY OF THE INVENTION

The main objective of the present invention is to provide a casing structure of portable electronic device, simplify the complexity of portable electronic device of prior art, moreover, diminishes the working hours needed for production. Two or more elements of portable electronic device are fabricated simultaneously in a one time manufacturing process because of the notion of unifying upper and lower cover of external casing, LCD frame, and positioning frame. Binding new fashion for assembling using the ability of metal to bend to plait the structure into 3-D embodiment, in order to attain simplifying parts and lessen working hours.

The minor objective of the present invention is to provide a casing structure of portable electronic device using the characteristics of lightweight, fine EMI obviation, quality heat dissipation of metal to resolve the failings of heavyweight, no EMI prevention, poor heat dissipation exists in prior art.

A further objective of the present invention is to provide a casing structure of portable electronic device using the capacity of various processing of metal to glorify its visage. For example, the surface of metal can use machine tools such as planer, lathe to manufacture or adhere ornaments by all means making the mien no longer prosaic.

The present invention alter elements of casing structure of portable electronic device of prior art utterly, accordingly, the present invention simplifies the element of portable electronic device. Take a notebook base for instance, the present invention can realize the following merits with one single element:
1. Rigidity needed for being a base
2. Allocating room for electronic elements
3. Excellent shielding effect

Embellishing appearances coordinate with easy to process, lower cost ornament, thus the demand to control production cost effectively can be met. Further lessen the weight and width of computer to content the trend.

### BRIEF DESCRIPTION OF THE DRAWINGS

FIG. 1 is an exploded view of a notebook in prior arts;

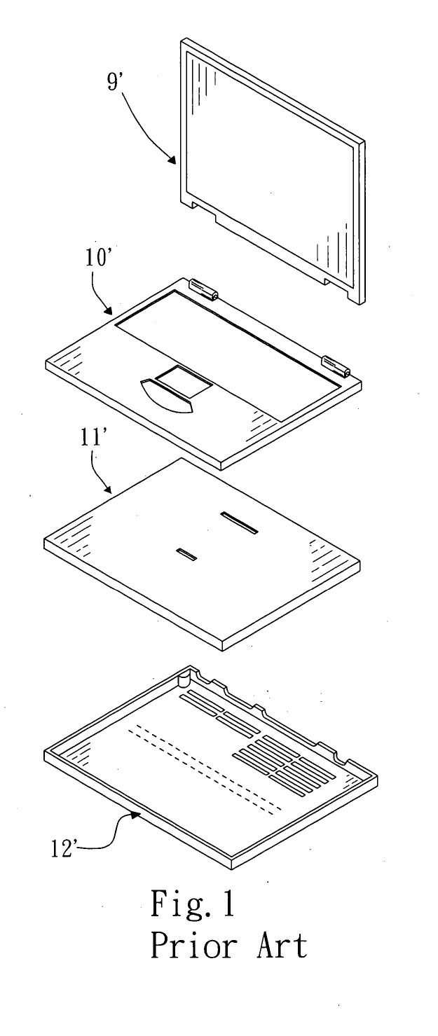

FIG. 2 is a layout of a first preferred embodiment of the present invention;

FIG. 3 is an illustration of the first preferred embodiment of a casing and a cover plate of the present invention;

FIG. 4 is an illustration of a base plate of the present invention;

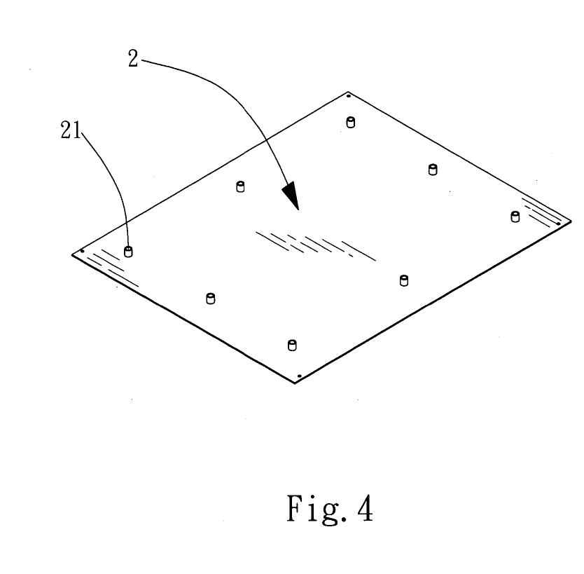

FIG. 5 is a layout of a second preferred embodiment of the present invention;

FIG. 6 is a 3-D sketch of the second preferred embodiment of the present invention;

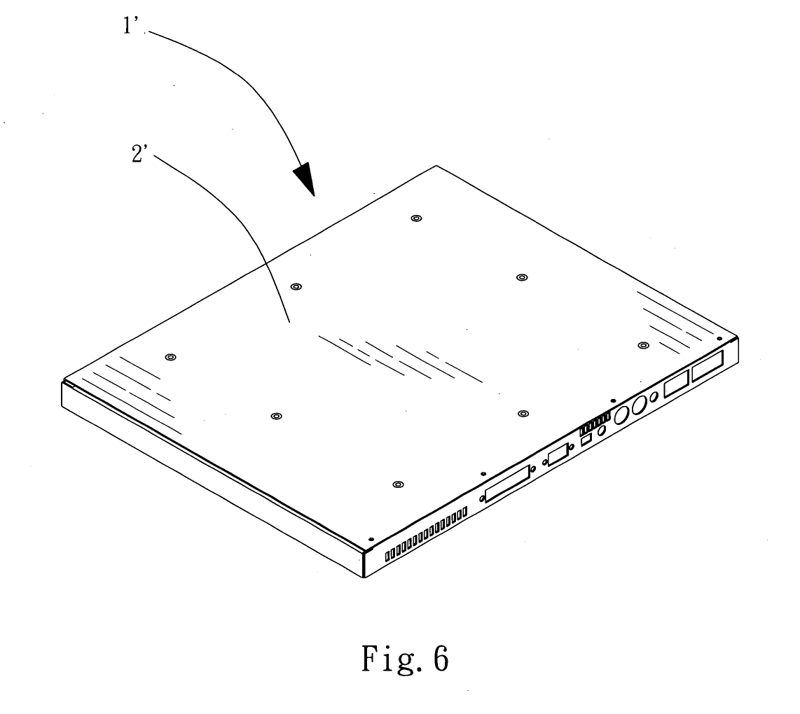

FIG. 7 is a flow diagram of formation of a casing structure of the present invention;

FIG. 8 is a sketch of decorations attached to the casing of the present invention;

### DETAILED DESCRIPTION OF THE PREFERRED EMBODIMENTS

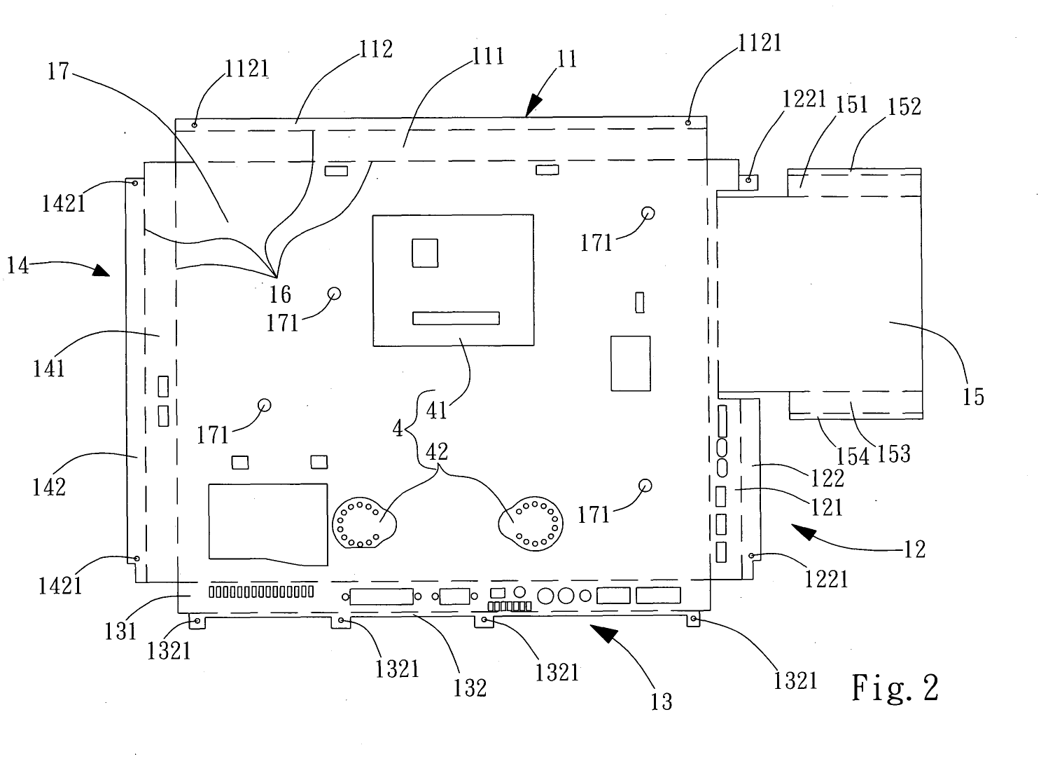

Please refer to FIG. 2, which is a layout of a first preferred embodiment of the present invention. Trim a layout of a notebook casing 1 on an aluminum alloy metal sheet, and fold the foresaid metal sheet along a plurality of creases 16.

The casing 1 comprises of a first crease 11, a second crease 12, a third crease 13, a fourth crease 14, an upper plate 15 of a reader and an upper plate 17. The first crease 11 further comprises of lower crease 111 and upper crease 112, the same applies to the second crease 12, the third crease 13, and the fourth crease 14 respectively. Using the creases 16 as a basis, folding lower creases (111, 121, 131, 141) and upper plate 17 respectively to a right angle forming a 3-D prototype of casing 1. As abovementioned, after first time folding, the upper plate 15 of the reader is folded parallel to upper plate 17 along the crease 16 between upper plate 15 and lower crease 121.

Folding the crease 16 between the first lower crease 151, upper plate 15, second lower crease 153 of the reader reversely, forming a perpendicular angle reciprocally. At this point, preliminary outline of the reader is surfacing. Between crease 16 and the first upper crease 152, first lower crease 151, second upper crease 154, second lower crease 153 of the reader was folded outwards creating a plumb angle respectively.

For second time folding, lower creases (111,121,131,141) and upper creases (112, 122, 132, 142) were bent 90 degrees respectively along crease 16, making upper creases (112, 122, 132, 142) parallel to upper plate 17. To this point, casing 1 is complete, alternatively, a region 3 is looming.

A plurality of positioning hole (1121, 1221, 1321, 1421, 171) located on upper creases (112, 122, 132, 142, 17) respectively which interlocks with other elements. As for the apertures in various shape and size on 121, 131 are connectors for USB, PS/2, COM port etc. A region 4 located on upper plate 17 further comprises an I/O region 41 and a speaker region 42.

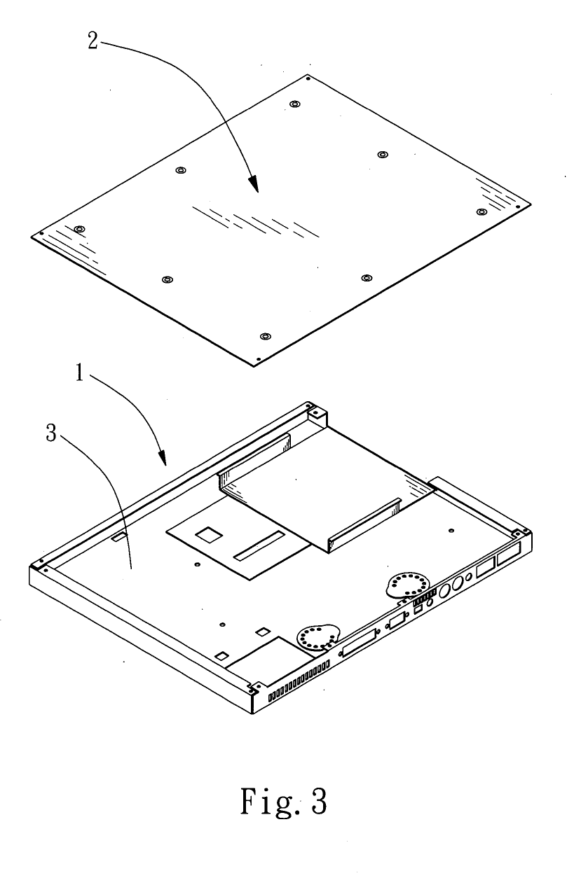

Please refer to FIG. 3, showing a first preferred embodiment of a casing and a cover plate of the present invention. It clearly states the 3-D aspect of the metal sheet shown in FIG. 2 after the folding process. A motherboard module can be placed in region 3 when the motherboard module positioned by a plurality of pins 21 of the cover plate 2 capped on the opening of casing 1.

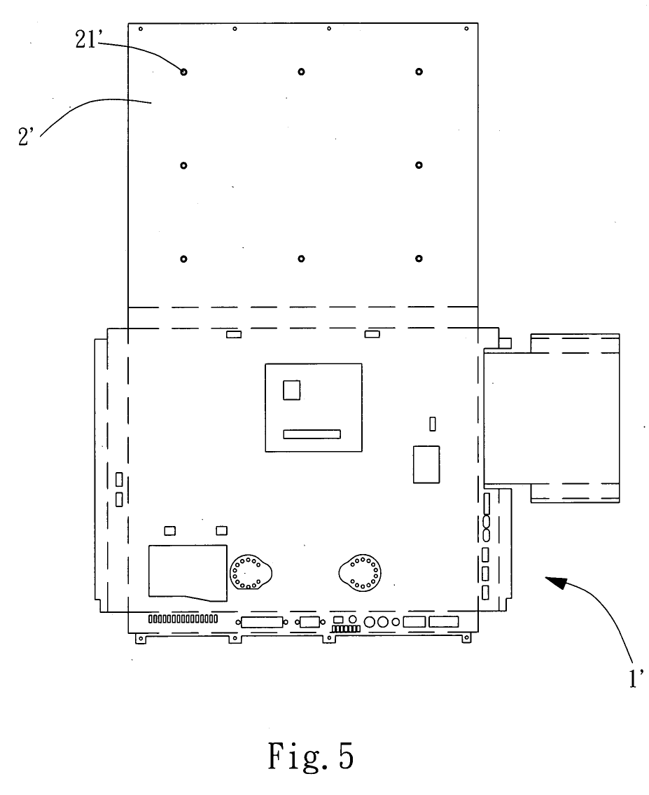

Please refer to FIG. 5, which is a layout of a second preferred embodiment of the present invention. The first upper crease 112 (as shown in FIG. 2) extends further to the opening of casing 1′ where plane 2′ folds in, replacing the covering plate 2 (as shown in FIG. 3) in advance. A motherboard module can be placed in region 3′ when the motherboard module positioned by a plurality of pins 21′ of the plane 2′, thus completing casing 1′ by bending and fixing.

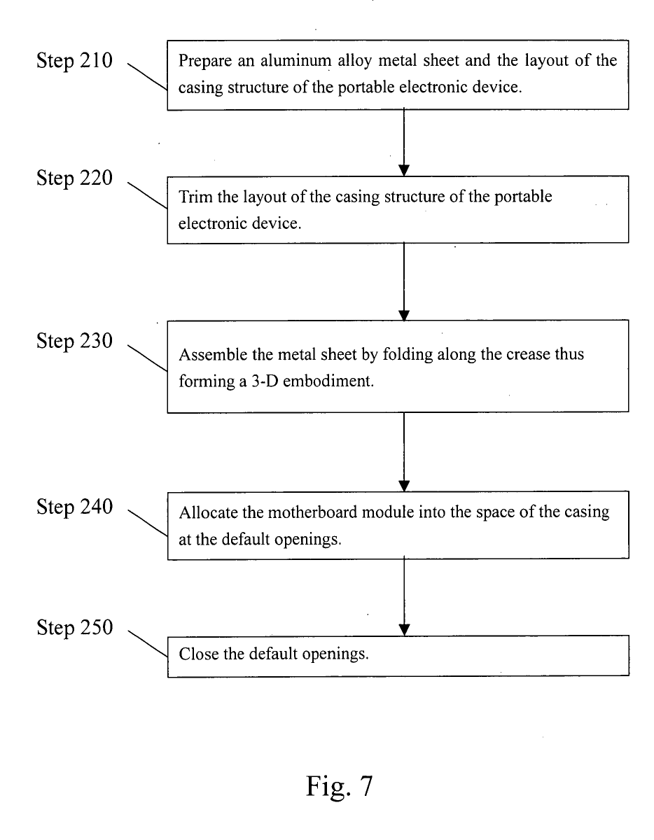

Please refer to FIG. 7, which is a flow diagram of formation of a casing structure of the present invention. The following is a briefing on the flow diagram:
1. Prepare an aluminum alloy metal sheet and the layout of the casing structure of the portable electronic device. (Step 210)
2. Trim the layout of the casing structure of the portable electronic device. (Step 220)
3. Assemble the metal sheet by folding along the crease thus forming a 3-D embodiment. (Step 230)
4. Allocate the motherboard module into the space of the casing at the default openings. (Step 240)
5. Close the default openings. (Step 250)

The fore-mentioned steps can fabricate casing 1 of the portable electronic device conveniently, at the same time possess the advantages of lessen working hours, lower cost, enhanced precision.

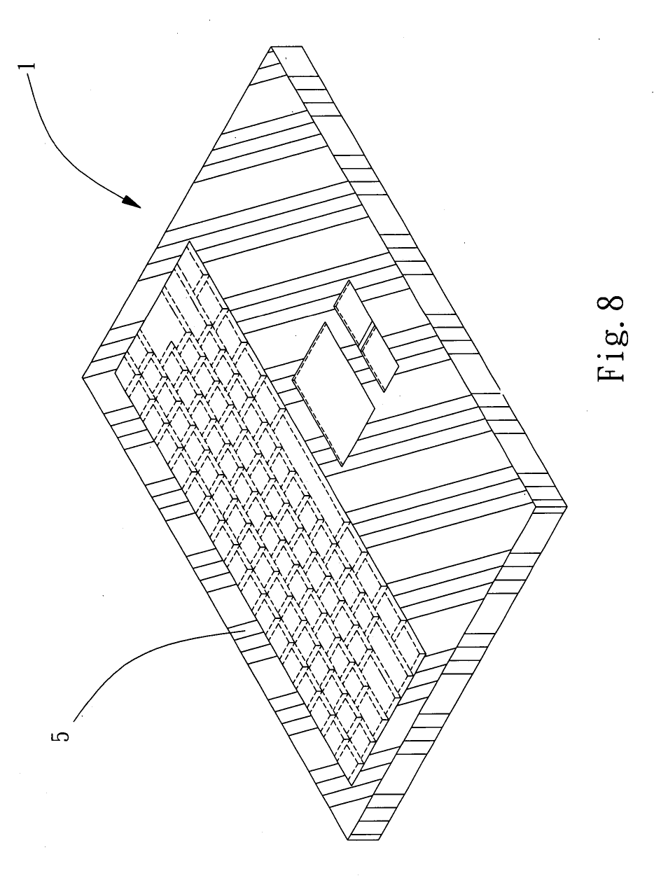

In addition, decorations (FIG. 8) or carvings may be attached to the surface of the casing to enhance its mien.

The features of the present invention conclude as follows:
1. The present invention simplifies prior art of casing structure of the portable electronic device. The thickness of metal sheet employed in the present invention is merely 0.8 mm, or even thinner, while retaining quality rigidity.
2. Light metal is much easier to recycle than plastics. Light metal restore back to raw material state after recycling while plastics are unable to do so. Thus, it is far more environmental friendly than plastics.
3. Heat dissipation is a major issue for portable electronic device. The power consumption of the recent portable electronic device is nearly reaching the limit of technology up-to-date. By directing heat to casing 1, which has a broader surface area for heat dissipation, there is no need for a further electric-driven element for heat dissipation.
4. Any plastic materials do not have the capability of EMI absorption, unless doped or sputtered with substance which is competent of assimilating EMI. Light metal sheets are able to absorb the EMI emerged from the operating frequency of the portable electronic device thoroughly.
5. Quote per unit light metal is lower than that of plastic material, while far lower than the Magnesium-Aluminum alloy molding material. The casing of portable electronic device made of engineering plastic other than the extra thickness needed for essential rigidity, metals are electroplated for EMI shielding purpose after molding. Alternatively, the light metal casing does not bear the foresaid drawbacks. Therefore, lowering cost and higher value is added to the electronic portable device.

The present invention can use machine tools such as planer, lathe to manufacture, adhere ornaments 5 or carvings on the surface of metal sheet fulfilling customization requisition.

Although the present invention has been described with reference to preferred embodiments thereof, it is apparent to those skilled in the art that a variety of modification and changes that may be made without departing from the scope of the present invention which is intended to be defined by the appended claims.

1. A casing structure of a portable electronic device, where the portable electronic device consisted of a predetermined casing made by bendable metal, the casing comprising an installing room for locating and positioning electronic elements, a positioning region located on a surface of the casing structure for installing external elements, an opening being on other surfaces excluding the surface with the positioning region so as to that the electronic elements entering to the installing room.

2. The casing structure of the portable electronic device as claimed in claim 1, a covering body is allocated at the opening.

3. The casing structure of the portable electronic device as claimed in claim 2, a plurality of positioning pins are installed on the covering body.

4. The casing structure of the portable electronic device as claimed in claim 1, the electronic elements consist a motherboard module.

5. The casing structure of the portable electronic device as claimed in claim 1, the positioning region includes an input/output (I/O) device region.

6. The casing structure of the portable electronic device as claimed in claim 1, the region includes a speaker device region.

7. The casing structure of the portable electronic device as claimed in claim 1, a decoration member is attached to the surface of the casing.

8. The casing structure of the portable electronic device as claimed in claim 1, a carving is enchased to the surface of the casing.

9. The casing structure of the portable electronic device as claimed in claim 1, the casing is made of aluminum alloy texture.

10. The casing structure of the portable electronic device as claimed in claim 1, the portable electronic device is a notebook.

11. The casing structure of the portable electronic device as claimed in claim 1, the portable electronic device is a tablet PC.

12. The casing structure of the portable electronic device as claimed in claim 1, the portable electronic device is a personal digital assistant (PDA).

13. A casing structure of a portable electronic device, where the portable electronic device consisted of a predetermined casing made by bendable metal, the casing comprising an installing room for installing and positioning electronic elements, an opening being on other surface excluding the surface with the positioning region so as to that the electronic elements entering to the installing room, while an extendable covering folded plate installed at a side of the opening, which sealing the opening aptly.

14. The casing structure of the portable electronic device as claimed in claim 13, a plurality of positioning pins are installed on the covering body or the folded plate.

15. The casing structure of the portable electronic device as claimed in claim 13, the electronic elements consist a motherboard module.

16. The casing structure of the portable electronic device as claimed in claim 13, the region includes an input/output (I/O) device region.

17. The casing structure of the portable electronic device as claimed in claim 13, the region includes a speaker device region.

18. The casing structure of the portable electronic device as claimed in claim 13, a decoration member is attached to the surface of the casing.

19. The casing structure of the portable electronic device as claimed in claim 13, a carving is enchased to the surface of the casing.

20. The casing structure of the portable electronic device as claimed in claim 13, the casing is made of aluminum alloy texture.
